(19) United States
(12) Patent Application Publication
(10) Pub. No.: US 2014/0061133 A1
(43) Pub. Date: Mar. 6, 2014

(54) Method and Apparatus for Split-Flow-Mixing Liquid Chromatography

(71) Applicant: Joseph Lewis HERMAN, West Chester, PA (US)

(72) Inventor: Joseph Lewis HERMAN, West Chester, PA (US)

(21) Appl. No.: 13/601,669

(22) Filed: Aug. 31, 2012

(51) Int. Cl. B01D 15/18; B01D 15/08

(52) U.S. Cl. 210/659; 210/198.2

(57) ABSTRACT

A method for chromatographically separating analytes of a liquid sample comprises: (i) providing the sample in a conduit; (ii) providing a solvent for the sample; (iii) causing the solvent to simultaneously flow into the conduit so as to expel the sample from the conduit and flow into and through a second conduit so as to exit said second conduit; (iv) simultaneously providing the expelled sample and the exited solvent to a mixing tee-junction such that the expelled sample and the exited solvent mix thereat; (v) providing the mixture of the expelled sample and the exited solvent to a chromatographic column such that the analytes are transferred to the column and are chromatographically separated therein under the influence of a flow of the solvent, or a different solvent or a mixture of solvents.

### FIELD OF THE INVENTION

This invention relates to high performance liquid chromatography (HPLC), and more specifically to techniques for capturing small quantities of analytes injected in organic solvents onto HPLC columns, especially for the purpose of subsequent detection and analysis.

### BACKGROUND OF THE INVENTION

High-Performance Liquid Chromatography (HPLC) is widely used to separate analytes in liquid samples. Typical HPLC instruments use a high pressure pump for forcing a suitable sample-bearing mobile phase at a constant flow rate through one or more chromatographic separation columns. The sample components are separated within the separation column by one or more mechanisms including sorption, size exclusion, ion exchange or other interactions with the chromatography packing. The sample components are then detected by any conventional detector, e.g., a UV-visible detector, a fluorescence detector, an infrared detector, a mass spectrometer, a Raman detector, or a detector that measures refractive index or conductivity, as just a few examples.

The utility of separations by HPLC has been demonstrated over a broad range of applications including the analysis and purification of molecules ranging from low to high molecular weights. The separation process relies on the fact that a number of component solute molecules in a flowing stream of a fluid percolated through a packed bed of particles, known as the stationary phase, can be efficiently separated from one another. Generally, separation in liquid chromatography is achieved in a column by selective distribution of the sample molecules between a stationary phase and a mobile phase. The individual sample components are separated because each component has a different affinity for the stationary phase, leading to a different rate of migration for each component and a different exit time for each component emerging from the column. The separation efficiency is determined by the amount of spreading of the solute band as it traverses the bed or column.

Reversed-phase liquid chromatography (RP-HPLC) is widely used as a mode of separation in high performance liquid chromatography (HPLC). In the RP-HPLC technique, the solvent(s) employed in the mobile phase is/are more polar than the stationary phase, whereas the reverse situation is true in conventional (normal phase) chromatography performed prior to development of RP-HPLC. The mobile phase solvents typically employed in reversed phase liquid chromatography systems comprise water and one or more water-miscible organic modifiers, for example, acetonitrile or methanol. Analyte species of-interest typically form a solution with the mobile phase. The RP-HPLC stationary phase is usually highly hydrophobic or non-polar. The affinity of a chemical species for a stationary phase, which affects the rate at which the particular species in a flowing mobile phase passes through the stationary phase, results primarily from interaction of the species with chemical groups present on the stationary phase. These chemical groups may be provided on the stationary phase by reacting a surface-modifying reagent with a substrate, such as a silica substrate. Surface-modifying agents may thus be employed to adsorb specific chemical groups onto the stationary phase. Conventional reversed-phase liquid chromatography uses 3-10 μm spherical silica beads that have been modified by covalent attachment of hydrocarbon chains including 4, 8, or 18 carbon atoms to provide a non-polar surface.

One difficulty that may occur in the performing of RP-HPLC separations is that, when large volumes of analytes in organic solvents are injected into the chromatographic apparatus, the injected volume can exceed the column volumes resulting in the analytes not being able to be retained on a reversed phase HPLC stationary phase. Since there is an ongoing trend in the field of chromatography towards smaller (lower volume) columns, this difficulty has become more significant in recent years. In order to reduce the amount of total organic solvents in the mobile phase seen by the column when the sample volume reaches the column, one can mix the sample volume with an aqueous mobile-phase solvent prior to reaching the column. As an example, FIG. 1 illustrates a conventional HPLC system in which the mixing is performed prior to loading a sample into a chromatographic apparatus. FIGS. 2-3, discussed subsequent to the discussion of FIG. 1, illustrate examples of conventional HPLC systems in which the mixing is performed subsequent to loading.

As shown in FIG. 1A, an analyte-bearing sample in an organic solvent is provided from sample source 11 and mixed with aqueous solvent from solvent source 12 in mixing apparatus 19. The mixture is then delivered to a port of a multi-port valve 15 through tubing 2a under the impetus of pump 13a. The multi-port valve 15 is configured, during a loading step or stage, to deliver the mixture containing the sample portion to be analyzed to looped tubing 2c. Any excess solvent or sample is delivered to waste container 17 through tubing 2d, which is fluidically coupled to a port of the multi-port valve.

FIG. 10 is a schematic illustration of an example of a multi-port valve as may be employed within systems in accordance with the present teachings. The multi-port valve 15 shown in FIG. 10 comprises, in known fashion, a stator portion 46 having a plurality of bores or passageways 47 therein passing through the stator portion from one end to another end and a rotor portion 45 having a plurality of grooves or channels 48a-48c therein, the grooves or channels disposed on a side of the rotor portion 45 that faces the stator portion 46. As shown, the stator portion 46 comprises six bores or passageways 47 that correspond, for example, to the ports p1-p6 of the valve 15 as shown in FIG. 1A. The rotor portion 45 may rotate, as illustrated by the double-headed arrow in FIG. 10, so as to maintain faces of the rotor and stator portions in mutual contact and so that the grooves or channels 48a-48c may be configured so as to fluidically interconnect alternative sets of adjacent bores or passageways 47. Although a rotary valve is shown, the invention is not intended to be limited to such, as the rotary valve is but one example of a valve which may be employed.

It should be noted in reference to this and other of the appended drawings that tubing segments shown in either solid or dashed lines are thereby indicated as those segments through which fluid flow occurs, whereas tubing segments shown in dotted lines are thereby indicated as being inactive. Dashed lines are used—as opposed to solid lines—so as to indicate tubing segments though which a flow of mixed solvents occurs, the mixture including solvents provided by both sources 14a and 14b. It should be noted that the designations of “inactive” tubings only pertain to the discussion of the particular embodiment under discussion. Depending upon system configuration and operation, it is possible that some tubing segments shown as “inactive” with regard to the particular embodiment under discussion may, in fact, be actively transporting fluids in conjunction with some other function or process. As but one example, in some chromatographic systems, depending upon system configuration and mode of operation, the sample loop (tubing 2c) may be continuously provided with sample material from one or more sources, even during elution stages (i.e., FIG. 1C) during which time the sample loop tubing is indicated as being “inactive” according to the present discussions. It should be further noted that, although the word “tubing” is used in the present description to describe the means by which fluid is transferred from one location to another, one of ordinary skill in the art will readily recognize that such tubing lengths might be replaced by any form of conduit, such as channels that are etched or machined into one or more substrates. Accordingly, any form of conduit may be employed in place of tubing, per se. It should be still further noted that the looped tubing 2c is frequently referred to as an “injection loop”. The word “loop” as used herein and in the common usage in the art is not meant to necessarily imply any particular geometrical configuration of the tubing (or other form of conduit) but, instead refers to the fluidic coupling of the tubing, at its two ends, to two separate ports of the multi-port valve.

After collection of a portion of the mixture containing the sample portion to be analyzed, the valve is reconfigured as shown in FIG. 1B so as to deliver the portion of the mixture to a chromatographic column 18. In the “injection” configuration shown in FIG. 1B, an aqueous mobile phase solvent provided by solvent source 14b is caused to flow, under the impetus of pump 13b, through gradient valve 16 and tubing 2b so as to enter a port of the multi-port valve 15 and thereby mix with and expel the mixture portion previously collected in tubing 2c. The expelled mixture of sample and solvents passes through tubing 2e to the chromatographic column 18. In this injection stage or step, the mobile phase solvent is chosen such that the analyte or analytes are preferentially partitioned onto the stationary phase. In this way, the analyte or analytes are preferably “focused” on the stationary phase—in other words, caused to reside within a narrow zone of the stationary phase within the column by adsorbance onto the stationary phase.

During the elution stage or step of the conventional system 10 (FIG. 1C), the gradient valve 16 is configured so as to provide a mixture of solvents from the two solvent sources 14a, 14b into the tubing 13b. The multiport valve may be configured so as to deliver the mixture of solvents directly to tubing 2e and then to column 18. The solvents are chosen such that the analyte or analytes have a greater affinity for the solvent from solvent source 14a than for the solvent from solvent source 14b. Using the RP-HPLC technique, this condition is generally fulfilled by choosing the solvent from source 14a so as to be more non-polar than or less aqueous than the solvent from source 14b. During the course of the elution, the gradient valve may be operated so as to progressively increase the proportion of the solvent from solvent source 14a. In this way, analytes may be removed from the column one-by-one in the reverse order from the strength of their binding onto the stationary phase. The thus separated analytes are passed out of the column and delivered sequentially to a detector 9.

As noted above, in some situations, an undesirable situation may occur in which the injected volume of organic material exceeds the column volume, as a result of a high volume of organic solvent. The high organic content thereby causes an undesirable situation in which there will be no absorption to the stationary phase of the analytes of interest, i.e. the analytes of interest are not retained on the column. FIG. 1, discussed above, illustrates one conventional solution to this problem in which the volume of organic solvents is diluted with an aqueous mobile phase prior to being loaded into the chromatographic system. This solution suffers from a possible disadvantage in that, if the analytes of interest are initially present in low concentration in the original sample, then the subsequent dilution with aqueous solvent may cause insufficient analyte material to be retained within the loop tubing 2c during a loading step.

FIG. 2 represents a second conventional chromatographic system 20 in which mixing with an aqueous solvent is performed using an in-line mixing, apparatus 27. Because the mixing is performed subsequent to sample loading, the system 20 does not include an external mixing apparatus, such as the mixing apparatus 19 shown in FIG. 1. Instead, undiluted sample from sample source 11 is delivered into the tubing 2a during the loading step (FIG. 2A). Other aspects of the loading step are similar to those already discussed in reference to FIG. 1.

In the subsequent injection step, (FIG. 2B), the collected sample is expelled from tubing 2c and into tubing 2e by flushing with solvent from solvent source 14b as previously described above with reference to FIG. 1B. However, in contrast to the operation illustrated in FIG. 1B, the tubing 2e does not immediately direct the sample into the column 18. Instead, the sample fluid is passed through an intervening in-line mixing apparatus 27 within which it is mixed with and diluted by the aqueous solvent that flushes it from and follows it out of the tubing 2c. The mixing of the sample with the aqueous solvent dilutes the concentration of organic solvent within the mobile phase that is delivered to the column such that adsorption of the analytes of interest onto the stationary phase can occur.

Various types of in-line mixing apparatuses are available for use as the mixing apparatus 27. These devices generally incorporate some form of internal flow disruption mechanism—such as inert granules, baffles or vanes, spinning propellers, off-axis fluid introduction ports, etc.—so as to increase the interaction path length and interaction volume within which separately introduced fluids are able to mix. Such mixing devices are available in various sizes. Various such devices are also known as “mixing columns”. For mixing a sample with a diluent, the internal volume of the mixing apparatus is ordinarily chosen based on the extent to which the percentage of introduced organic solvents needs to be diluted in order for the analyte of interest to be retained by the column.

As one example, the volume of the aqueous solvent provided to the mixing apparatus 27 by solvent source 14b may be controlled to be up to three-times, four-times, etc. greater than the volume of sample provided from looped tubing 2c, thereby diluting the concentration of all sample and solvent species originally present in sample source 11 by at least a factor of 3, 4, etc. The sample and diluent flow into the mixing device so as to fill and mix within its internal volume prior to being released to the column 18. This feature of the operation of the in-line mixing device adds additional system void volume and can add additional delay to the sample analysis. Thus, for example, if a sample of 100 μL is introduced into the mixing device and a dilution to 20% of the original concentration is required, then an in-line mixing device having an internal volume of 500 μl would be conventionally employed. For this sample size, a common flow rate is, however, just 500 μL per minute. Thus, the use of a conventional apparatus would add at least one minute to each sample separation. This added time may become significant in an automated system (for example, in a clinical laboratory) in which many samples are run consecutively.

FIG. 3 depicts a third conventional chromatographic system 29. Similarly to the operation of the system 20 (FIG. 2) the mixing of the sample with aqueous solvent is performed, within the chromatographic system 29, subsequent to sample loading and downstream from the multi-port valve 15. However, instead of employing an in-line mixing apparatus, the system employs an auxiliary gradient valve 29 in conjunction with an auxiliary pump 23 and auxiliary source 21 of aqueous solvent. Tubing 2f delivers a flow of aqueous solvent from the auxiliary solvent source 21 at a chosen flow rate so as to continuously mix with and dilute the sample that is provided to the auxiliary gradient valve 15 through tubing 2e. Alternatively, the aqueous solvent, could be drawn from the solvent source 14b.

Whereas the in-line mixing apparatus 27 of the system 20 (FIG. 2) performs mixing of the entire volume of sample together with an entire chosen volume of solvent, the auxiliary gradient valve of the system 29 (FIG. 3) performs continuous mixing of the flows of sample and solvent provided by the tubing segments 2e and 2f, respectively. As one example, the rate of flow of the aqueous solvent provided by solvent source 21 may be controlled to be up to three-times, four-times, etc. greater than the flow of sample that passes through tubing 2e, thereby diluting the concentration of all sample and solvent species originally present in sample source 11 by at least a factor of 3, 4, etc. The ratio between the rates of flow of sample and solvent may be controlled by the auxiliary gradient valve 25.

Despite the dilution of the sample in either the system 20 (FIG. 2) or the system 29 (FIG. 3), all or most analyte species are retained for subsequent detection, since their flow through the column is arrested by adsorbance onto the stationary phase within the column 18. By contrast, the pre-dilution technique illustrated in FIG. 1 may reduce the total amount of analyte available for detection as a result of the finite volume of diluted sample collected in looped tubing 2c. In the elution stage (FIG. 3C), either the auxiliary pump 23 is turned off or the auxiliary valve 25 is configured to prevent flow of the aqueous solvent from the auxiliary solvent source 21. In operation of either the system 20 or the system 29, the elution stage proceeds essentially as previously described in reference to FIG. 1C, with a mixture of solvents being supplied to the column 18 from the two solvent sources 14a, 14b. A programmed time variation in the relative proportions of the two solvents delivered to the column may be employed so as to remove analyte species from the column sequentially so as to be detected, each in turn, by the detector 9.

Although the conventional chromatographic techniques illustrated in FIGS. 1-3 and discussed above can be and have been employed successfully, they each suffer some drawbacks. For example, the conventional pre-dilution technique illustrated in FIG. 1 requires an additional sample preparation step and, as noted above, can reduce the total amount of analyte available for detection. The conventional in-line mixing technique illustrated in FIG. 2 introduces additional “dead volume” into the fluid pathway as noted above. The additional dead volume may degrade chromatographic separation and resultant data quality and also introduces additional time delay. The system 29 illustrated in FIG. 3 requires the chromatograph system to include an additional pump as well as an additional valve, thereby increasing system cost and size.

In light of the above considerations, there is a need in the art for a chromatography method and apparatus that can successfully capture and detect small levels of organic analyte species in the presence of excess organic solvent without requiring an extra pump and mixing apparatus and without adverse effects on spectral quality or analysis speed.

### SUMMARY

According to a first aspect of the present teachings, a method for chromatographically separating analytes of a liquid sample is provided, wherein the method comprises: (i) providing the sample in a conduit; (ii) providing a solvent for the sample; (iii) providing a fluidic pump; (iv) operating the fluidic pump so as to simultaneously cause the solvent to flow into the conduit so as to expel the sample from the conduit and cause the solvent to flow into and through a second conduit so as to exit said second conduit; (iv) simultaneously providing the expelled sample and the exited solvent to a mixing tee-junction such that the expelled sample and the exited solvent mix thereat; (v) providing the mixture of the expelled sample and the exited solvent to a chromatographic column such that the analytes are transferred to the column and are chromatographically separated therein under the influence of a flow of the solvent, a different solvent or a mixture of solvents. In various embodiments, the analytes become adsorbed to a stationary phase within the chromatographic column and, in such embodiments, the method may comprise an additional step (vi) of providing a fluid comprising a second solvent to the chromatographic column such that the adsorbed analytes are sequentially desorbed from the stationary phase and expelled from the chromatographic column. In instances of isocratic elution, the composition of the fluid comprising the second solvent does not vary with time; in instances of gradient elution, the composition of the fluid is time-varying.

The step (ii) of providing a solvent for the sample may comprise providing the solvent in a fashion such that, when mixed with the sample at the mixing tee-junction, the solvent causes dilution of the total organic solvent content of the sample. In various embodiments, the step (iii) may include causing a flow of the solvent to pass through a splitting tee-junction so as to be split thereat into a first flow portion that flows into the conduit and a second flow portion that flows into and through the second conduit. In various other embodiments, the step (iii) may include causing a flow of the solvent to pass through a three-port valve so as to be split thereat into a first flow portion that flows into the conduit and a second flow portion that flows into and through the second conduit, said three-port valve having a flow adjustment mechanism operable to control a ratio between flow rates of the first and second flow portions. The flow adjustment mechanism may be controlled manually or automatically. Also, the step (iii) may comprise, in various embodiments, splitting a flow of the solvent into a first flow portion that flows into the conduit through a multi-port valve and a second flow portion that bypasses the multi-port valve. The ratio between a flow rate of the first flow portion and a flow rate of the second flow portion may be controlled by choosing a length or inner diameter of the second conduit.

In some embodiments, the step (vi) of providing a fluid comprising a second solvent to the chromatographic column may comprise varying a composition of the fluid with time, wherein said time variation is calibrated so as to compensate for a difference in flow rates of the first and second flow portions. In various other embodiments, the step (vi) may include configuring a flow adjustment mechanism such that fluid does not flow through the second conduit.

According to a second aspect of the present teachings, a chromatography system is provided, the system comprising: (a) a multi-port valve comprising first port fluidically coupled to the sample source; and at least a second port, third port, fourth port and fifth port, wherein the multi-port valve comprises a first configuration in which the third and fifth ports are fluidically coupled and the second and fourth ports are fluidically coupled; (b) an injection loop conduit fluidically coupled to the second and third ports; (c) at least one source of solvent for the sample fluidically coupled to the fourth port so as to provide one or more solvents to the fourth port; (d) a fluidic pump fluidically coupled between the source of solvent and the fourth port operable to cause the one or more solvents to flow through the system; (e) a first tee-junction fluidically coupled between the fluidic pump and the fourth port; (f) a chromatographic column fluidically coupled to the fifth port so as to receive the liquid sample therefrom; (g) a second tee-junction fluidically coupled between the chromatographic column and the fifth port; and (h) a bypass conduit fluidically coupled between the first and second tee-junctions, wherein the bypass conduit or one of the first and second tee-junctions is configured such that, when the multi-port valve is in its first configuration, the one or more solvents provided from the at least one solvent source under the operation of the pump are split into a first flow portion provided to the injection loop conduit and a second, greater flow portion provided to the bypass conduit.

Some embodiments may further comprise: (i) a second multi-port valve comprising: a second-valve first port operable to provide the one or more solvents to the first tee-junction; a second-valve second port operable to receive the one or more solvents from the fluidic pump, a second-valve third port operable to provide the liquid sample or the one or more solvents to the chromatographic column; and a second-valve fourth port operable to receive a combination of the a first flow portion and the second flow portion from the second tee-junction, wherein the second multi-port valve comprises a first configuration in which the first and second ports are fluidically coupled and the third and fourth ports are fluidically coupled and a second configuration in which the second and third ports are fluidically coupled.

### BRIEF DESCRIPTION OF THE DRAWINGS

The above noted and various other aspects of the present invention will become apparent from the following description which is given by way of example only and with reference to the accompanying drawings, not drawn to scale, in which:

FIGS. 1A-1C are schematic depictions of chromatography loading, injection and elution stages, respectively, in accordance with a first conventional chromatography system and method;

FIGS. 2A-2C are schematic depictions of chromatography loading, injection and elution stages, respectively, in accordance with a second conventional chromatography system and method;

FIGS. 3A-3B are schematic depictions of chromatography loading and injection stages, respectively, in accordance with a third conventional chromatography system and method;

FIGS. 4A-4C are schematic depictions of chromatography loading, injection and elution stages, respectively, in accordance with a first chromatography system and method of the present teachings;

FIG. 5 is a schematic depiction of the elution stage in accordance with a second chromatography system and method of the present teachings;

FIGS. 6A-6C are schematic depictions of chromatography loading, injection and elution stages, respectively, in accordance with a third chromatography system and method of the present teachings;

FIG. 7 is a schematic depiction of the chromatography injection stages in accordance with another chromatography system and method of the present teachings and representing a modified version of the system and method depicted in FIG. 6;

FIG. 8 is a schematic illustration the elution step of another chromatography system in accordance with the present teachings;

FIG. 9 is a set of chromatograms of 100 μL injections of 2 μg/mL solutions of testosterone in methanol, one chromatogram obtained using a conventional configuration and the other chromatogram obtained employing a system in accordance with the invention;

FIG. 10 is a schematic illustration of an exemplary rotary valve assembly as may be employed as a multi-port valve within an apparatus in accordance with the present teachings;

FIG. 11 is a schematic illustration of an exemplary tee-junction; and

FIG. 12 is a flow diagram of a chromatography method in accordance with the present teachings.

### DETAILED DESCRIPTION

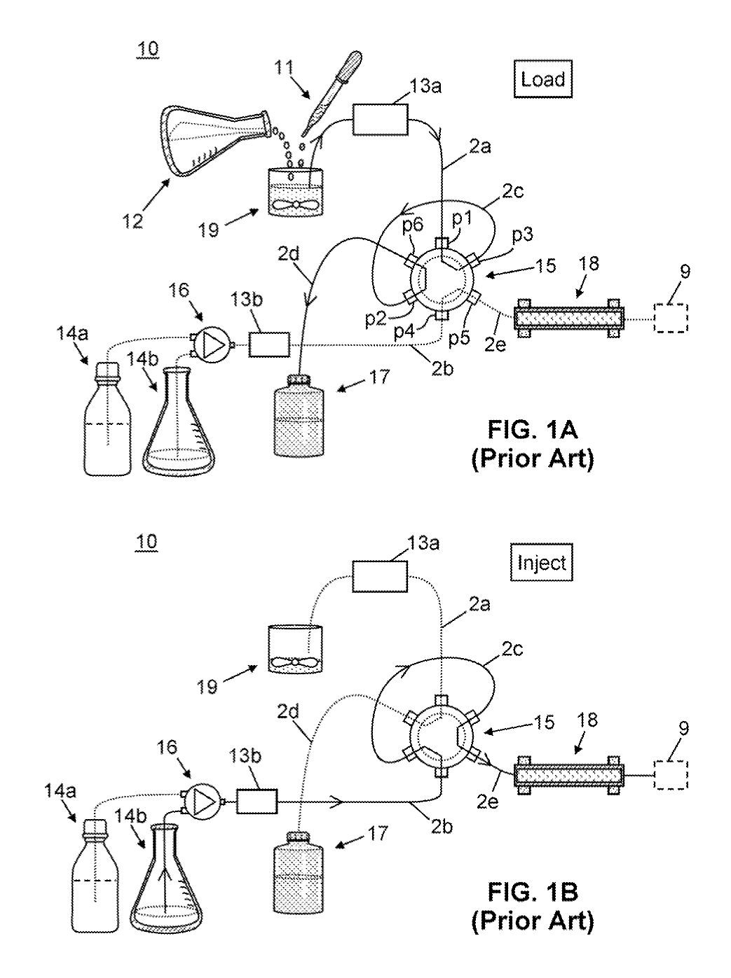

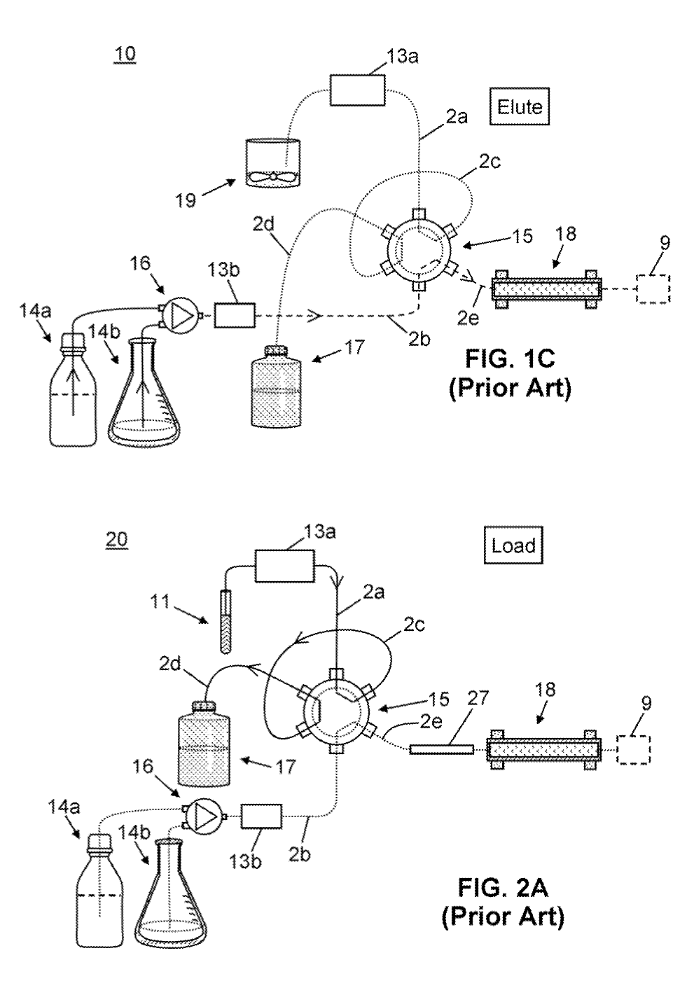

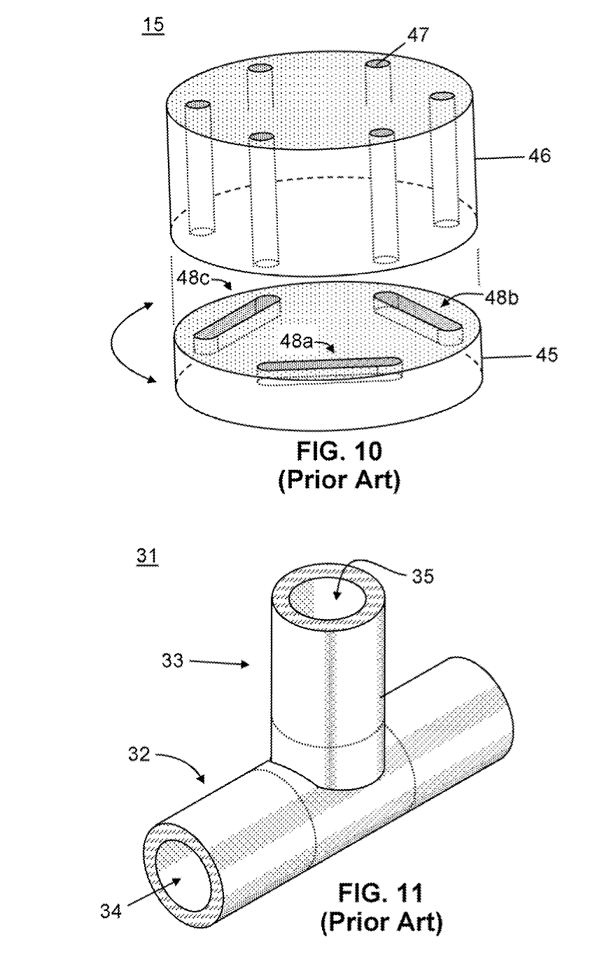

The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described. The particular features and advantages of the invention will become more apparent with reference to the appended FIGS. 1-12, taken in conjunction with the following description.

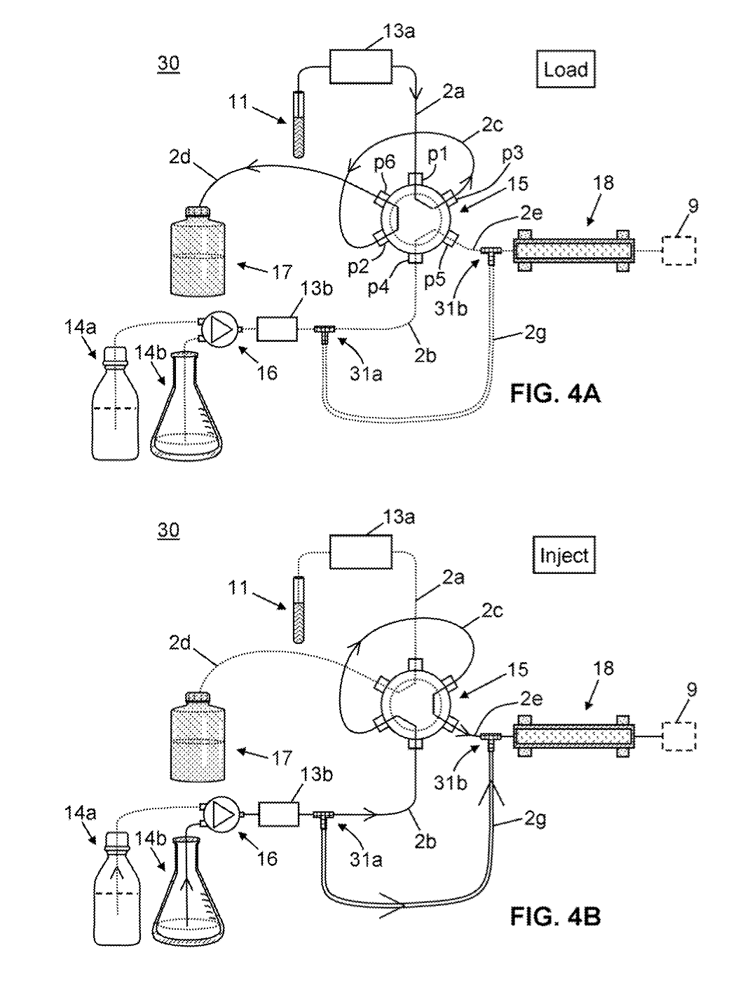

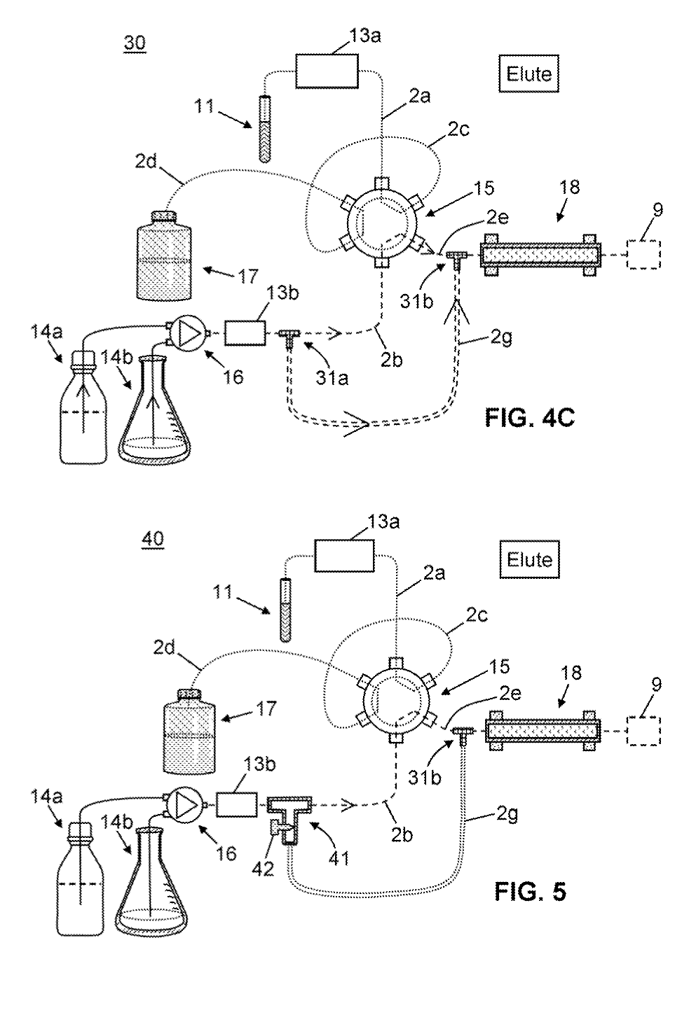

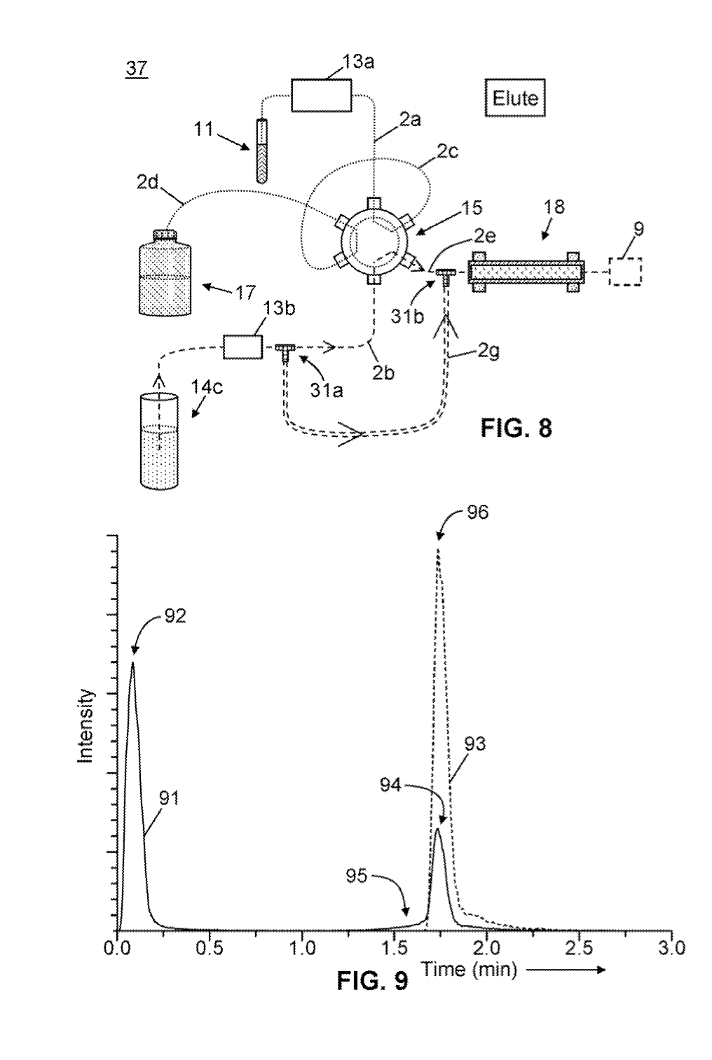

The present invention may be practiced in conjunction with chromatographic methods and systems employing either gradient elution or isocratic elution. Gradient elution, which is the most common type, is illustrated in detail in FIGS. 4-7 and in the following discussion pertaining to those figures. Some variations relating to isocratic elution are illustrated in FIG. 8 as well as in a following discussion pertaining to that figure.

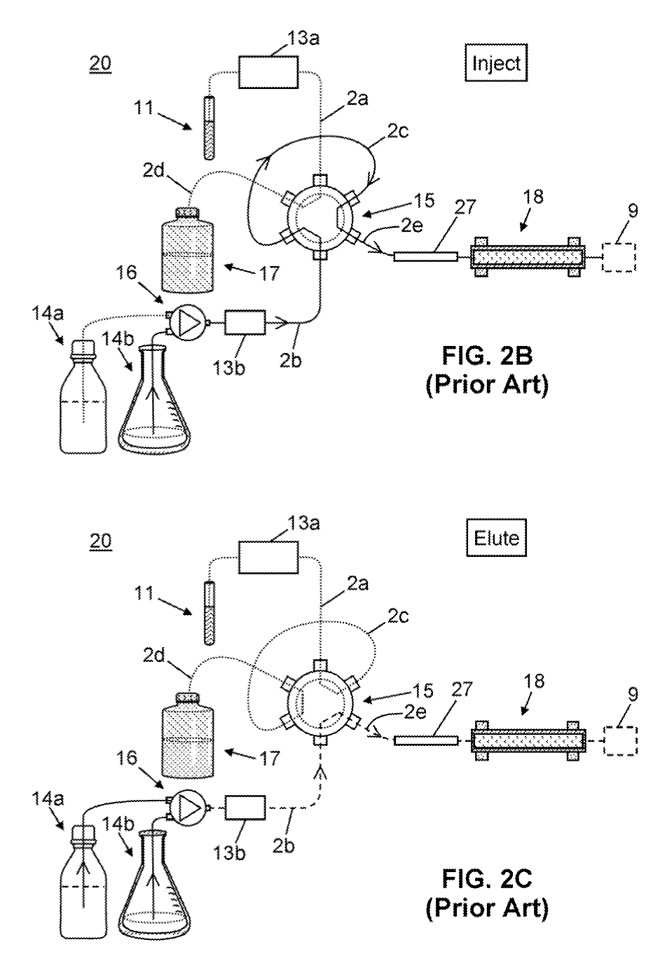

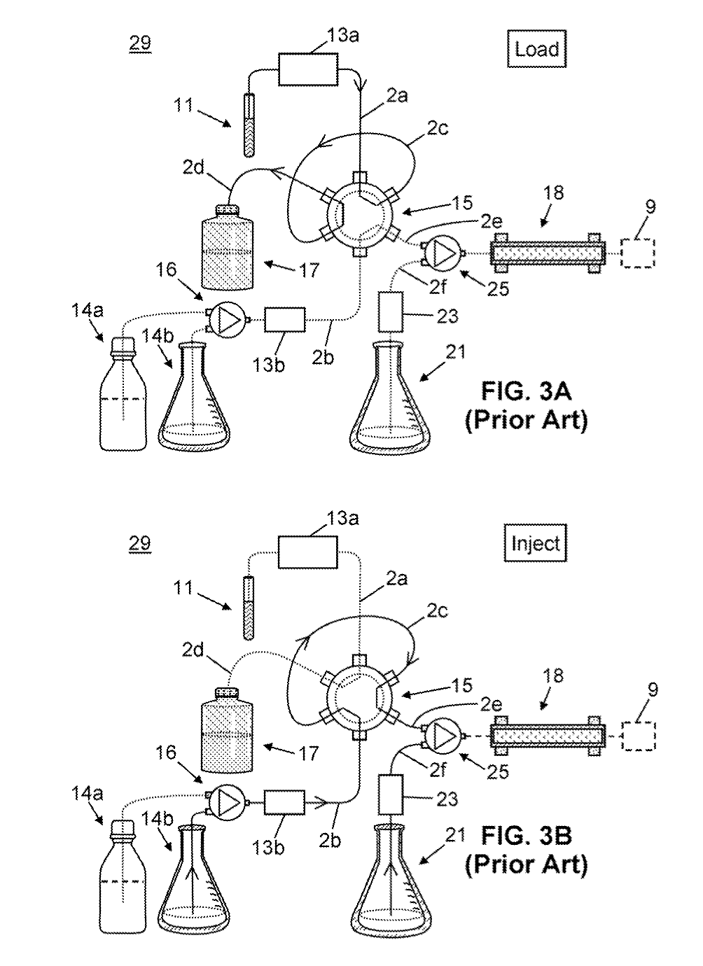

FIGS. 4A-4C are schematic depictions of chromatography loading, injection and elution stages, respectively, of a first chromatography system in accordance with the present teachings. The system 30 illustrated in FIG. 4 comprises many components that are identical are similar in function and disposition to components in the chromatography systems 10 (FIG. 1), 20 (FIG. 2) and 29 (FIG. 3). Such identical or similar components are recognized by their similar reference numbers, with regard to FIGS. 1-3, and the reader is referred to the above discussion in the background section for descriptions of these components and their functions. For reference, the first, second, third, fourth, fifth and sixth ports of the multi-port valve 15 are respectively labeled as ports p1, p2, p3, p4, p5 and p6 in FIG. 4A. This scheme of port labeling is understood to apply throughout this description; however, the numbering of the ports is arbitrary. Although the multi-port valve 15 is illustrated as comprising exactly six ports circularly arranged in the appended drawings, it should be understood that valves with some other total number of ports or with some different geometrical configuration of the ports could also be employed, provided that such valves are able to fluidically interconnect the various ports as shown and described herein.

Similarly to the functioning of the system 29 (FIG. 3), the system 30 (FIG. 4) operates so as to mix diluent aqueous solvent with sample fluid at a position that is fluidically between the injection loop tubing 2c and the chromatographic column 18. However, in contrast to the system 20, the system 30 includes neither the auxiliary solvent source, the auxiliary pump, the auxiliary valve, nor the in-line mixing apparatus. Instead, in the system 30, a portion of the solvent or solvents provided by the solvent sources 14a, 14b during the injection stage (FIG. 4B) is diverted into a bypass tubing 2g by a splitting tee-junction 31a that is fluidically disposed upstream from the multi-port valve 15. The remaining portion of the solvent or solvents—that is, the portion that is not split off into bypass tubing 26—continues, during the injection stage, to flow into tubing 2b from which it proceeds to mix with the sample in injection loop tubing 2c and to expel the sample from that tubing, as described above. The diverted portion of the solvent or solvents mixes with the sample fluid, during the injection stage at mixing tee-junction 31b just prior to entry of the sample and solvents into the column 18.

Each of the splitting tee-junction 31a and the mixing tee-junction 31b may be in the form of a simple fluid tubing connecting device 31 as is schematically illustrated in FIG. 11. For clarity of description, it is here noted that a “tee-junction” (or alternatively, a “T-junction”) is generally a device that may be roughly shaped (or approximately shaped) in the form of the alphabetic letter “T” and that is used to interconnect three separate lengths of fluid tubing. For example, the tee-junction 31 shown in FIG. 4 comprises an integral device that includes a first tube-like portion 32 having bore 34 and an intersecting second tube-like portion 33 having bore 35. In operation, three respective fluid tubing lengths are fluidically coupled to the two ends of bore 34 and to the end of bore 35. A fluid flow entering the device 31 from a first end of bore 34 will, in general, split into two flow portions such that one flow portion exits through an opposite end of bore 34 and such that the other flow portion exits through bore 35. Also, the device 31 may be used for mixing two entering fluid flow portions into a single mixed fluid flow that exits the device. Although the second tube-like portion 33 is illustrated as being at right angles to the first tube-like portion 32 in FIG. 11, it should be understood that, in fact, these tube-like portions may be disposed at any acute or oblique angle to one another. For example, some tee-junctions may be configured in the form of the letter “Y” or shaped similarly to an arrow head so as to assist in fluid convergence or divergence Thus, the term “tee-junction”, as used herein, is meant to encompass all such variations.

Comparison of FIG. 4B with either FIG. 2B or FIG. 3B shows that the mixing tee-junction 31b fulfills the function of diluting the sample fluid with aqueous solvent, similar to the function performed by the in-line mixing apparatus 27 of the system 20 or the combination of the pump 23 and the gradient valve 25 of the system 29. However, in the novel system 30, the auxiliary pump is eliminated, since diluent aqueous solvent is provided to the mixing tee-junction 31b from bypass tubing 2g under the impetus of the pump 13b. This elimination of the conventionally used auxiliary pump reduces system cost, size and complexity. The relative proportioning of solvent flow, at the splitting tee-junction 31a, between the bypass tubing 2g and the tubing 2b may be controlled or determined by the relative fluid resistance between the two fluidic pathways between which the flow is split. For example, if the length of the fluidic pathway between the tee-junctions along the bypass tubing 2g is kept equal to the total length of the alternative fluidic pathway that includes the tubing 2b, tubing 2c and tubing 2e as well as the total fluidic pathways through the multi-port valve 15, then the relative flow rates may be determined by the ratio of the inner diameters at the most constricted portions of the respective pathways. Accordingly, the relative proportioning could, in this example, be set by choosing a bypass tubing 2g having a certain inner diameter. In FIG. 4 as well as in subsequent figures, the bypass tubing 2g is schematically illustrated as being thicker than other tubing segments, so as to carry the larger flow proportion. Alternatively, the resistance to fluid flow within the bypass tubing 2g could be controlled by choosing the length of the tubing, by choosing both the length and inner diameter of the tubing or by choosing some other property or some combination of properties of the tubing or its connections.

Furthermore, the conventionally used in-line mixing apparatus 27 is eliminated, in the system 30, in favor of the simple mixing tee-junction 31b, thereby reducing cost and eliminating additional dead volume and the time delay associated with the in-line mixing apparatus 27. Because there is merely a confluence of separate fluid flows, essentially no additional dead volume is introduced by the use of the lee-junction 31b. Accordingly, any adverse effects of such additional dead volume are eliminated in the novel system.

The column injection stage of the operation of the system 30 has been described in the above paragraphs with reference to FIG. 4B. The operation of the loading stage (FIG. 4A) is similar to that already described in reference to FIGS. 1-3 and such description is not repeated here. The operation of the elution stage of the system 30 is illustrated in FIG. 4C. As previously described, during the elution stage, the relative proportions of the two solvents provided from solvent sources 14a, 14b may be varied with time during the elution process (gradient elution) so as to yield a series of solvent mixtures of different compositions. Since the simple splitting tee-junction 31a may not have a shut-off capability, the flow of all such mixtures may be split between two pathways as shown in FIG. 4C.

The splitting of mobile phase between the two pathways (at the tee-junction 31a) may cause the time variation of the composition of the mobile phase during performance of a gradient elution to deviate from what it would otherwise be in the absence of the bypass tubing 2g. For example, the fluid resistance and length of the bypass tubing may be such that a portion of the mobile phase having a certain composition that is diverted into the bypass tubing 2g is caused to arrive at the mixing tee-junction 31b slightly sooner (or later) than the portion of the same composition that flows through the valve 15. In such a situation, the composition of the mobile phase that exits in the mixing tee-junction 31b at any given time may be different from what would be predicted using a conventional system (i.e., without the bypass tubing 2g and the tee-junctions 31a, 31b). This effect may be compensated through a calibration procedure that determines how the proportions of the mobile phase solvents determined by the gradient valve 16 should be adjusted, in time, so as to account for the non-simultaneous arrival times. The resulting calibration—comprising timing adjustments of the gradient valve—could then be incorporated into any existing chromatography method.

Alternatively, a configuration as shown in FIG. 5 could be employed in order to control the splitting of the flow of mobile phase solvents. In the alternative system 40 shown in FIG. 5, the splitting tee-junction is replaced by a three-port valve 41 having a flow adjustment mechanism 42, such as, for instance a needle valve mechanism, that can vary the proportion of flow diverted into tubing 2g from zero percent to some positive percentage, perhaps up to 100 percent. In this fashion, the pathway of elution solvents may be controlled. Further, the flow adjustment mechanism 42 could also be employed during the column injection stage so as to control the relative proportioning of aqueous solvent between tubing 2b and the bypass tubing 2g thereby controlling or choosing the dilution factor at the mixing tee-junction 31b. Control of the adjustment mechanism 42—either manual control or automatic control—may thus be employed to variably configure the dilution factor for optimal use with each of various different samples, different solvents, or different analytical methods. Automatic control may be provided by a computer or other programmable controller device (not shown) that is electronically coupled to the adjustment mechanism.

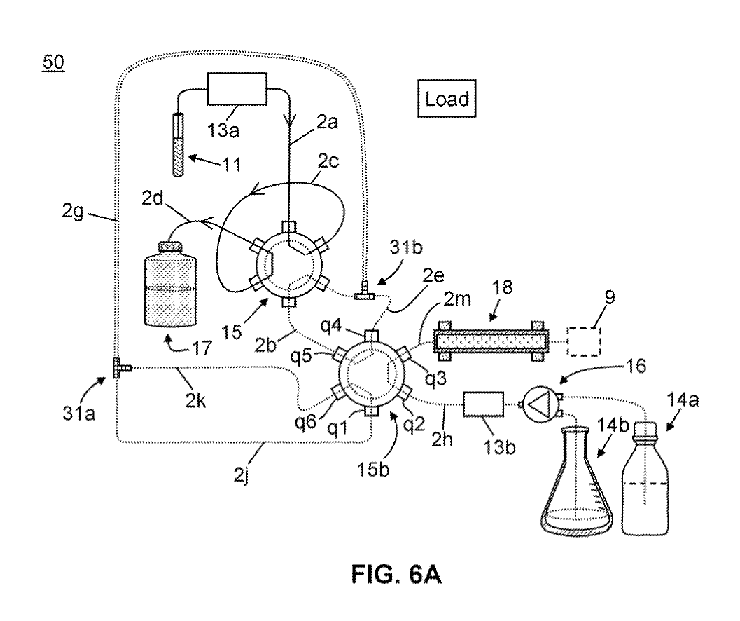

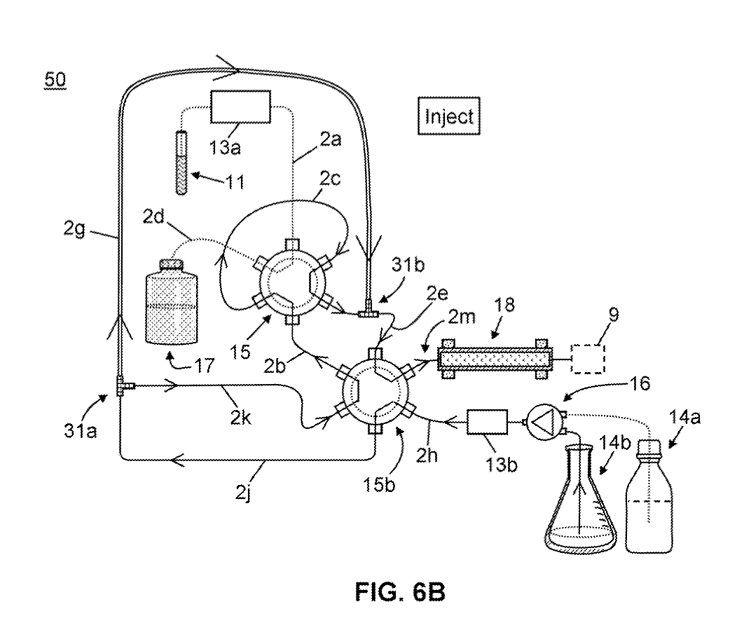

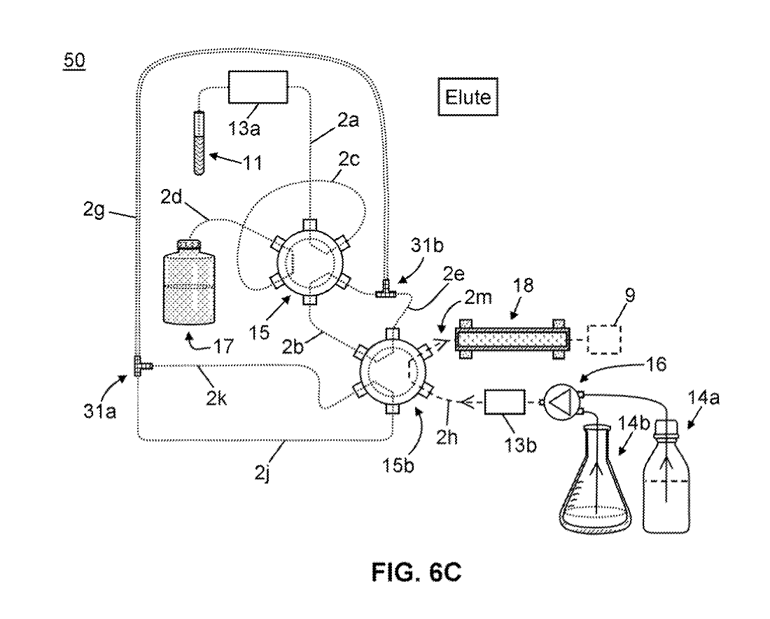

FIGS. 6A-6C are schematic depictions of chromatography loading, injection and elution stages, respectively, in accordance with a third chromatography system 50 in accordance with the present teachings. The system 50 illustrated in FIG. 6 includes any components in common with the system 30 previously described with reference to FIG. 4. These common components include: the sample source 11; first pump 13a; multi-port valve 15; waste container 17; solvent sources 14a, 14b; gradient valve 16; second pump 13b; tubing segments 2a, 2b, 2c, 2d, 2e and 2g and tee-junctions 31a and 31b. The functions of these common components are identical or essentially similar between the system 30 and the system 50. The system 50 further includes a second multi-port valve 15b that is fluidically interposed: (a) between the second pump 13b and the first multi-port valve 15; (b) between the second pump 13b and the column 18; (c) between the second pump 13b and the splitting tee-junction 31a; (d) between the column 18 and the mixing tee-junction 31 and, optionally, (e) between the splitting tee-junction 31a and the first multi-port valve 15. As illustrated, the second multi-port valve 15b may comprise six ports; these are labeled as second-valve ports q1, q2, q3, q4, q5 and q6 in FIG. 6A. The provision of the second multi-port valve 15b necessitates the inclusion of additional tubing segments, such as tubing segments 2h, 2j and 2k and 2m shown in FIG. 6.

The loading, stage of operation of the system 50 (FIG. 6A) is similar to the loading stage of the operation of the system 30 (FIG. 4A). The injection stage (FIG. 6B) is, likewise, similar to the injection stage of the operation of the system 30 (FIG. 4B) in that the flow of aqueous solvent from solvent supply 14b is split at splitting tee-junction 31a into (a) a first portion that flows through the valves 15b, 15 and through the sample loop tubing 2c so as to flush sample fluid out of the sample loop tubing 2c and into the column 18 and (b) a second, larger portion, that is diverted into bypass tubing 2g and serves to dilute the sample at mixing tee-junction 31b. The main difference during this injection stage, relative to the system 30, is that the fluid flows pass through the second multi-port valve 15b.

During the operation of the elution stage of the system 50 (FIG. 6C), the second multi-port valve 15b is configured such that the flow of the mixture of solvents provided from solvent supplies 14a, 14b does not pass through the sections of tubing leading to the tee-junctions 31a, 31b but, instead, flows directly from the second valve to the chromatographic column 18. This configuration precludes the possibility of the elution solvent mixtures being unnecessarily split into two portions at the splitting tee-junction 31a and minimizes the total length of the fluid pathway between the second pump 13b and the column 18. This configuration thus improves performance efficiency of the system 50 relative to the system 30.

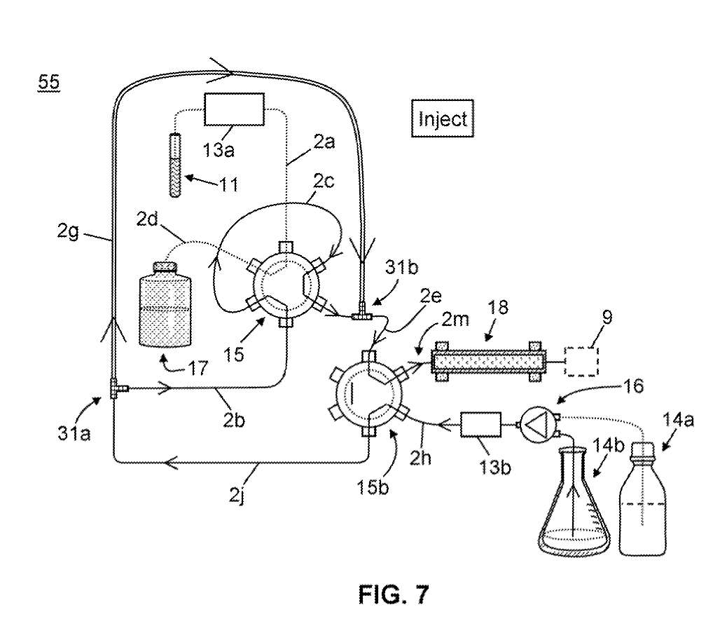

FIG. 7 illustrates another chromatography system 55, for which only the injection configuration is shown. The system 55 shown in FIG. 7 is a modified version of the system 50 shown in FIG. 6 that is configured such that the flow of the one or more solvents provided from solvent supplies 14a, 14b only passes through the second multi-port valve 15b a single time. The configuration shown in FIG. 7 frees two ports of the six-port valve 15b. The freed ports could thus be employed for other purposes or fluid connections. Alternatively, the six-port valve 15b shown in FIG. 7 could be replaced by a less-costly four-port valve.

FIG. 8 illustrates the elution step of a chromatography system 37 that is a variation of the system 30 shown in FIG. 4. The system 37 is set up for isocratic elution. Accordingly, the gradient valve 16 of the system 30 is removed and the two solvent supplies 14a, 14b are replaced by a single solvent supply 14c which may contain a pre-mixed mixture of solvents that are optimized for use as a mobile phase during the elution step. The solvent mixture may be chosen so as to be sufficiently polar or aqueous so as to adequately dilute the organic content of the sample during mixing at the mixing tee-junction 31b, yet sufficiently non-polar such that analytes in the sample migrate through the column under the influence of the flow of the mobile phase. Still further, the separate column injection and elution steps could be replaced by a single “flow-through” step, similar to traditional chromatography, in which analytes are both introduced into and separated within the column under a continuous flow of the particularly-chosen solvent composition.

Isocratic elution may also be achieved using many other variations or configurations. For example, the basic structure of the system 30 could be retained, but modified such that the solvent supply 14a contains a pre-mixed mixture of solvents that are optimized for use during an isocratic elution step. In such a configuration, the valve 16 may be operated, during the injection step, so as to draw solvent from solvent supply 14b, as described previously. However, during the elution step, the valve 16 would be operated so as to draw solvent only from the solvent supply 14a containing the solvent mixture (instead of from both solvent supplies). In this situation, the gradient valve 16 could be replaced by a simpler three-port switching valve that only draws solvent from a chosen one of the solvent supplies, but not from both. One of ordinary skill in the art will readily recognize how to modify other embodiments illustrated in the accompanying drawings for use with isocratic elution.

FIG. 9 is a comparison between chromatograms obtained employing a conventional chromatography configuration and employing a configuration in accordance with the invention. The chromatogram 91 and the chromatogram 93 represent experimental detection of testosterone after processing through the conventional chromatography system and a system in accordance with the invention, respectively. In each instance, the sample was a 100 μL injection of a 2 μg/mL solution of testosterone in methanol.

Because of the high concentration of organic solvent (methanol), the chromatogram 91 obtained using the conventional configuration exhibits a large spurious peak 92 at the initial solvent front at which the first compounds to exit the column are detected. The spurious peak 92 results from the detection of testosterone which remained solution in the mobile phase within the column as a result of its inability to be fully adsorbed onto the column stationary phase during column injection. The chromatogram 91 also exhibits a small peak 94 attributable to testosterone observed at the expected retention time of approximately 1.75 minutes. Although the peak 94 represents detection of a small proportion of testosterone which was adsorbed onto the stationary phase, its intensity severely under-represents the concentration of testosterone in the sample because a significant proportion of the testosterone exited the column at the beginning of the elution and because an unknown quantity of testosterone was flushed through the column during the injection step. The peak 94 also exhibits poor form, as illustrated by the peak fronting region 95.

By contrast, the chromatogram 93 obtained using the chromatographic system in accordance with the invention exhibits only a single well formed peak 96 at the testosterone retention time. The intensity of and area under the peak 96 are greater than the corresponding features of the peak 94 and are representative of the testosterone concentration because essentially all of this analyte was retained on the column stationary phase during injection, as evidenced by the absence of any spurious peak at the beginning of the elution.

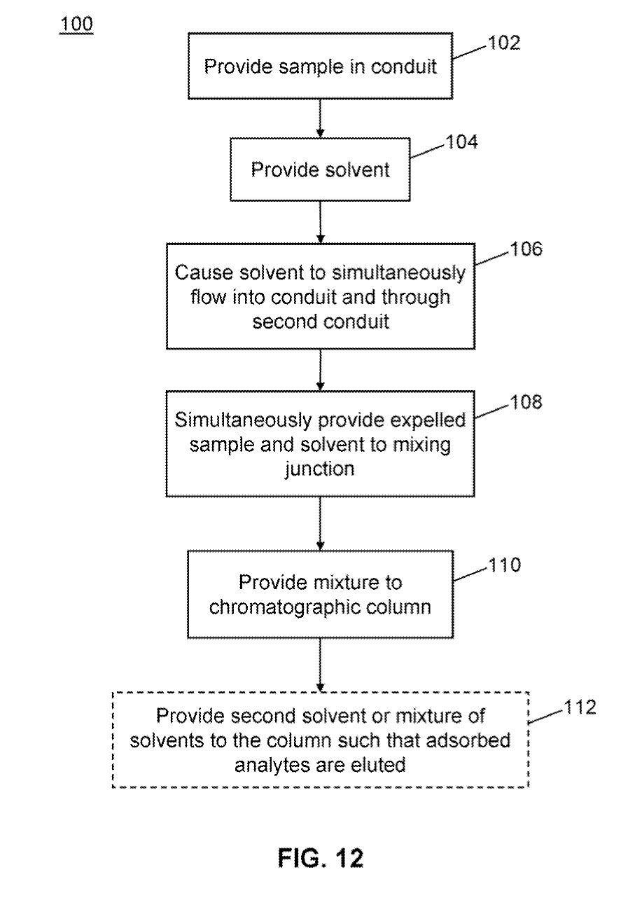

FIG. 12 is a flow diagram of a chromatography method in accordance with the present teachings. In the first step, Step 102, of the method 100 (FIG. 12), a sample that contains analytes of interest is provided in a conduit. For example, the injection loop—that is, sample loop tubing 2c illustrated in several of the appended drawings—serve as a suitable conduit within which the sample is provided. In the next step, Step 104, a solvent for the sample is provided. A mixture of solvents may alternatively be provided.

In the next step, Step 106, of the method 100 (FIG. 12) the solvent or solvents is (are) caused to simultaneously flow into the conduit so as to expel the sample from the conduit and flow into and through a second conduit so as to exit the second conduit. The pathway through to the first conduit may include a pathway through a valve to which the first conduit is fluidically coupled and the second conduit may be a bypass tubing that bypasses the valve. The simultaneous flow through the two pathways may be caused by splitting a total flow of the solvent (or solvents) from a solvent source between the two pathways by a splitting junction—such as a splitting tee-junction—or by a three-port valve that can be configured—either manually or automatically—to provide, a variable splitting ratio between the two pathways. The splitting ratio may also be determined by the difference in resistance to fluid flow between the two pathways. The pathway having the smallest fluid resistance will receive the greater portion of the flow and vice versa. The fluid resistance—and, consequently, the flow splitting ratio—may be chosen or fixed by the difference between the inner diameters within each of the pathways or by the lengths of the pathways.

Next, in Step 108 of the method 100 (FIG. 12), the expelled sample and the solvent or solvents that passed through and exited the second conduit are mixed at a mixing junction, such as a mixing tee-junction. In Step 110, the mixture is provided to a chromatographic column. If “flow-through” isocratic elution is employed, such that there are not separate column injection and elution steps, then the method 100 may terminate after Step 110. In such a situation, a fluid of a single composition, possibly comprising a solvent mixture, is employed to both transport sample analytes into the column and to facilitate differential migration of the analytes through the column as a result of partitioning of the analytes between the mobile phase and a stationary phase within the column. Partitioning of the analytes into the stationary phase may be facilitated by the prior mixing at the mixing tee-junction (in the previous Step 108) so as to dilute the concentrations of organic solvents in the sample. In some embodiments, the thus-separated analytes may be passed to a detector for sequential detection.

If gradient elution is employed, then the mixture is provided to the column, in Step 110, such that analytes become adsorbed to the stationary phase within the chromatographic column. The adsorption may be facilitated by mixing at the mixing tee-junction (in the previous Step 108) so as to dilute the concentrations of organic solvents in the sample. In the case of gradient elution, then Step 112 is executed, in which a mobile-phase fluid comprising a second solvent and having a time-varying composition is provided to the chromatographic column such that the adsorbed analytes are sequentially desorbed from the stationary phase and expelled from the chromatographic column. Step 112 may also be executed in certain instances of isocratic elution. In such instances, the mobile phase composition is not time-varying during the course of elution. In some embodiments, the separated analytes exiting the column may be passed to a detector for sequential detection.

The discussion included in this application is intended to serve as a basic description. Although the present invention has been described in accordance with the various embodiments shown and described, the reader should be aware that the specific discussion may not explicitly describe all embodiments possible. One of ordinary skill in the art will readily recognize that many alternatives are implicit and that there could be many variations to the embodiments described. For example, one of ordinary skill in the art would readily recognize that, in accordance with common procedure, an additional multiport valve may be employed in variations of the illustrated chromatographic systems. For instance, such an additional valve may be fluidically disposed between the mixing tee-junction 31b and the column 18 and may comprise ports and tubing segments that are fluidically coupled to additional waste containers or solvent sources for the purpose of flushing tubing lines, flushing analytes out of the column in either a forward direction or a reverse direction, etc. Additionally, one of ordinary skill in the art would readily recognize that, in accordance with common procedure, an additional column may be employed in various of the illustrated chromatographic systems. For instance, many chromatographic systems employ two columns—a first column comprising a guard column or cleanup column and the second column comprising an analytical column.

Still further, although most of the above discussion relating to the invention pertains to reversed phase high performance liquid chromatography (RP-HPLC), it should be noted the invention also applies to any HPLC system where the injected sample is in a solution that needs to be modified by the mobile phase prior to reaching the HPLC column. For example, if a hydrophilic interaction liquid chromatography (HILIC) column were employed instead of a RP-HPLC column, then column injection of hydrophilic analytes would, under normal circumstances, typically employ an organic-rich mobile phase. However, if the sample itself comprises an over-abundance of water (such that not all of the analytes would be adsorbed onto the HILIC column stationary phase), then one could employ the above teachings as described—together with minor obvious modifications—so as to dilute the water concentration with an organic fluid. If a normal phase column were employed, a first organic phase might be diluted with a different organic phase of (for example) different hydrophobicity, but the invention would still be able to be applied. Accordingly, many modifications may be made by one of ordinary skill in the art without departing from the scope and essence of the invention. Neither the description nor the terminology is intended to limit the scope of the invention—the invention is defined only by the claims. Any patents, patent applications, patent publications or technical publications mentioned herein are explicitly incorporated herein by reference.

What is claimed is:

1. A method for chromatographically separating analytes of a liquid sample, the method comprising:
(i) providing the sample in a conduit;
(ii) providing a solvent for the sample;
(iii) causing the solvent to simultaneously flow into the conduit so as to expel the sample from the conduit and flow into and through a second conduit so as to exit said second conduit;
(iv) simultaneously providing the expelled sample and the exited solvent to a mixing tee-junction such that the expelled sample and the exited solvent mix thereat;
(v) providing the mixture of the expelled sample and the exited solvent to a chromatographic column such that the analytes are transferred to the column and are chromatographically separated therein under the influence of a flow of the solvent, or a different solvent or a mixture of solvents.

2. A method as recited in claim 1, wherein the step (ii) of providing a solvent for the sample comprises providing the solvent such that the solvent, when mixed with the sample at the mixing tee-junction, causes dilution of the total organic concentration of the sample.

3. A method as recited in claim 1, wherein the step (ii) of providing a solvent for the sample comprises providing the solvent such that the solvent, when mixed with the sample at the mixing tee-junction, causes dilution of the total water concentration of the sample.

4. A method as recited in claim 1, wherein the step (iii) includes causing a flow of the solvent to pass through a splitting tee-junction so as to be split thereat into a first flow portion that flows into the conduit and a second flow portion that flows into and through the second conduit.

5. A method as recited in claim 1, wherein the step (iii) includes causing a flow of the solvent to pass through a three-port valve so as to be split thereat into a first flow portion that flows into the conduit and a second flow portion that flows into and through the second conduit, said three-port valve having a flow adjustment mechanism operable to control a ratio between flow rates of the first and second flow portions.

6. A method as recited in claim 1, wherein the step (iii) comprises splitting a flow of the solvent into a first flow portion that flows into the conduit through a multi-port valve and a second flow portion that bypasses the multi-port valve.

7. A method as recited in claim 6, wherein the step (iii) further comprises setting a ratio between a flow rate of the first flow portion and a flow rate of the second flow portion by choosing a length or inner diameter of the second conduit.

8. A method as recited in claim 4, wherein the step (vi) of providing a fluid comprising a second solvent to the chromatographic column comprises varying a composition of the fluid with time, wherein said time variation is calibrated so as to compensate for a difference in flow rates of the first and second flow portions.

9. A method as recited in claim 5, wherein the step (vi) of providing a fluid comprising a second solvent to the chromatographic column includes configuring the flow adjustment mechanism such that the fluid does not flow through the second conduit.

10. A method as recited in claim 1, wherein the step (v) of providing the mixture of the expelled sample and the exited solvent to a chromatographic column is such that the analytes become adsorbed to a stationary phase within the chromatographic column and wherein the method further comprises:
(vi) providing, a fluid comprising the different solvent or the mixture of solvents to the chromatographic column such that the adsorbed analytes are sequentially desorbed from the stationary phase and expelled from the chromatographic column.

11. A chromatographic system for chromatographically separating analytes of a liquid sample provided from a sample source, the system comprising:
a multi-port valve comprising:
a first port fluidically coupled to the sample source; and
at least a second port, third port, fourth port and fifth port, wherein the multi-port valve comprises a first configuration in which the third and fifth ports are fluidically coupled and the second and fourth ports are fluidically coupled;
an injection loop conduit fluidically coupled to the second and third ports;
at least one source of solvent for the sample fluidically coupled to the fourth port so as to provide one or more solvents to the fourth port;
a fluidic pump fluidically coupled between the source of solvent and the fourth port operable to cause the one or more solvents to flow through the system;
a first tee-junction fluidically coupled between the fluidic pump and the fourth port:
a chromatographic column fluidically coupled to the fifth port so as to receive the liquid sample therefrom;
a second tee-junction fluidically coupled between the chromatographic column and the fifth port; and
a bypass conduit fluidically coupled between the first and second tee-junctions,
wherein the bypass conduit or one of the first and second tee-junctions is configured such that, when the multi-port valve is in its first configuration, the one or more solvents provided from the at least one solvent source under the operation of the pump are split into a first flow portion provided to the injection loop conduit and a second, greater flow portion provided to the bypass conduit.

12. A chromatographic system as recited in claim 11, wherein first tee-junction comprises a flow adjustment mechanism operable to control a ratio between the first flow portion and the second flow portion.

13. A chromatographic system as recited in claim 12, wherein the flow adjustment mechanism is electronically coupled to a controller that is operable so as to control the ratio by controlling the flow adjustment mechanism.

14. A chromatographic system as recited in claim 11, wherein the at least one source of solvent comprises a first solvent source having a first solvent and a second solvent source having a second solvent, and further comprising:
a gradient valve fluidically coupled between the fluidic pump and the first and second solvent sources, the gradient valve operable to cause a mixture of the first and second solvents to be drawn out of the first and second solvent sources under the operation of the fluidic pump.

15. A chromatographic system as recited in claim 11, further comprising:
a second multi-port valve comprising:
a second-valve first port operable to provide the one or more solvents to the first tee-junction;
a second-valve second port operable to receive the one or more solvents from the fluidic pump;
a second-valve third port operable to provide the liquid sample or the one or more solvents to the chromatographic column; and
a second-valve fourth port operable to receive a combination of the a first flow portion and the second flow portion from the second tee-junction,
wherein the second multi-port valve comprises a first configuration in which the first and second ports are fluidically coupled and the third and fourth ports are fluidically coupled and a second configuration in which the second and third ports are fluidically coupled.
